(19) United States
(12) Patent Application Publication
(10) Pub. No.: US 2026/0224069 A1
(43) Pub. Date: Aug. 6, 2026

(54) CHARCOAL GRILLING TOOL KIT FOR HANDLING HOT CHARCOAL BRIQUETTES

(71) Applicant: William Clary, JR., Covington, GA (US)

(72) Inventor: William Clary, JR., Covington, GA (US)

(21) Appl. No.: 19/046,947

(22) Filed: Feb. 6, 2025

(51) Int. Cl. A47J 37/07; A47L 13/34; F24B 15/10

(52) U.S. Cl. CPC A47J 37/0786; A47L 13/34; F24B 15/10

(57) ABSTRACT

A charcoal grilling tool kit for handling hot charcoal briquettes includes tongs, a shovel, and a rake. The tongs include a pair of arms having a first arm end and a second arm end. The arms are pivotably connected together at the first arm ends. Each arm includes a tong head that is positioned at the second arm end. The shovel includes a shovel shaft and a shovel head that is attached to the shovel shaft. The shovel head includes a front edge and a pair of side edges. The front edge is positioned perpendicular to a longitudinal axis of the shovel shaft. Each of the side edges is positioned parallel to the longitudinal axis of the shovel shaft. The rake includes a rake shaft and a rake head that is attached to the rake shaft. The rake head is positioned perpendicular to a longitudinal axis of the rake shaft.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention.

The disclosure relates to charcoal grilling accessories and more particularly pertains to a new charcoal grilling tool kit for handling hot charcoal briquettes. During charcoal grilling, it can be necessary to move the hot charcoal briquettes to different positions in the grill or to remove used charcoal briquettes and pieces or residue thereof. The charcoal grilling tool kit includes tongs for manipulating individual briquettes and pieces, a shovel to scoop one or more briquettes and scrape residue, and a rake for raking up briquettes and scraping residue off of a grate of the grill.

### (2) Description of Related Art including Information disclosed Under 37 CFR 1.97 and 1.98.

The prior art relates to hot coal handling devices grilling accessories, such as tongs and wire tools for handling individual charcoal briquettes. The prior art, as best understood, does not disclose a charcoal grilling tool kit for handling hot charcoal briquettes that includes tongs, a shovel, and a rake.

### (h) BRIEF SUMMARY OF THE INVENTION

An embodiment of the disclosure meets the needs presented above in a charcoal grilling tool kit for handling hot charcoal briquettes generally comprising tongs, a shovel, and a rake. The tongs include a pair of arms. Each of the arms includes a first arm end and a second arm end. The arms are pivotably connected together at the first arm end of each of the arms. Each of the arms includes a tong head that is positioned at the second arm end. The shovel includes a shovel shaft and a shovel head that is attached to the shovel shaft. The shovel head includes a front edge and a pair of side edges. The front edge is positioned perpendicular to a longitudinal axis of the shovel shaft. Each of the side edges is positioned parallel to the longitudinal axis of the shovel shaft. The rake includes a rake shaft and a rake head that is attached to the rake shaft. The rake head is positioned perpendicular to a longitudinal axis of the rake shaft.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(s)

The disclosure will be better understood and objects other than those set forth above will become apparent when consideration is given to the following detailed description thereof. Such description makes reference to the annexed drawings wherein:

FIG. 1 is a perspective view of a charcoal grilling tool kit according to an embodiment of the disclosure.

FIG. 2 is a perspective view of a shovel according to an embodiment of the disclosure.

FIG. 3 is a perspective view of rake according to an embodiment of the disclosure.

FIG. 4 is a perspective view of tongs according to an embodiment of the disclosure.

FIG. 5 is a perspective view of an embodiment of the disclosure in use.

### (j) DETAILED DESCRIPTION OF THE INVENTION

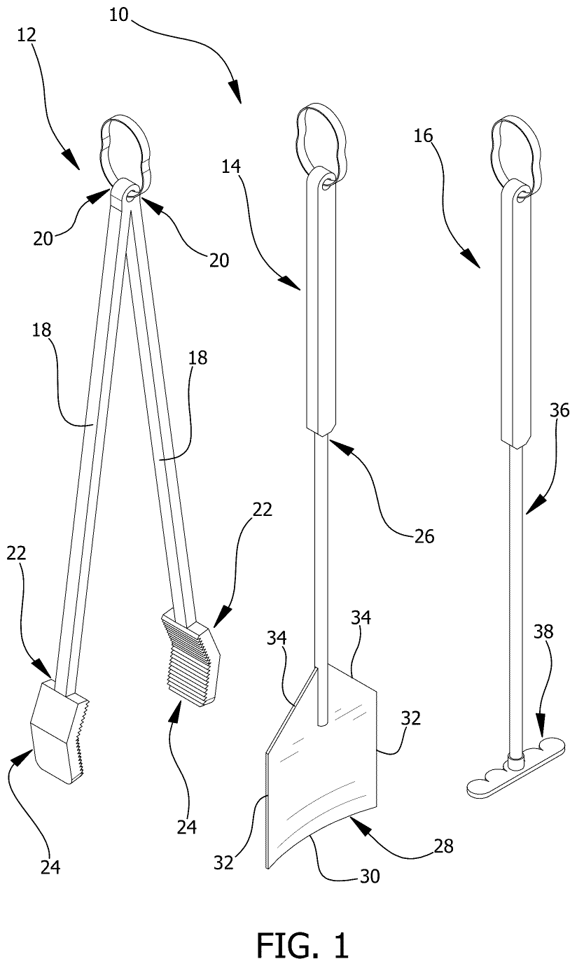

With reference now to the drawings, and in particular to FIGS. 1 through 5 thereof, a new charcoal grilling tool kit embodying the principles and concepts of an embodiment of the disclosure and generally designated by the reference numeral 10 will be described.

As best illustrated in FIGS. 1 through 5, the charcoal grilling tool kit 10 for handling hot charcoal briquettes 60, as well as cold ones, generally comprises tongs 12, a shovel 14, and a rake 16. The tongs 12 include a pair of arms 18. Each of the arms 18 includes a first arm end 20 and a second arm end 22. The arms 18 are pivotably connected together at the first arm end 20 of each of the arms 18. Each of the arms 18 includes a tong head 24 that is positioned at the second arm end 22. The shovel 14 includes a shovel shaft 26 and a shovel head 28 that is attached to the shovel shaft 26. The shovel head 28 includes a front edge 30 and a pair of side edges 32. The front edge 30 is positioned perpendicular to a longitudinal axis of the shovel shaft 26. Each of the side edges 32 is positioned parallel to the longitudinal axis of the shovel shaft 26. The rake 16 includes a rake shaft 36 and a rake head 38 that is attached to the rake shaft 36. The rake head 38 is positioned perpendicular to a longitudinal axis of the rake shaft 36.

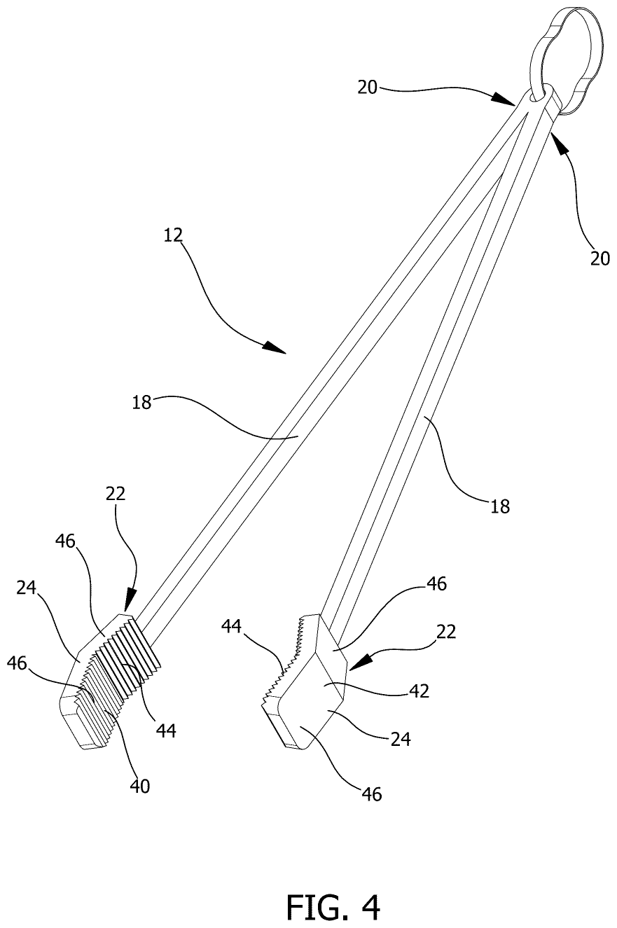

FIGS. 1 and 4 show an exemplary embodiment of the tongs 12. The tong head 24 has an inner head surface 40 and an outer head surface 42. The inner head surface 40 includes a plurality of teeth 44. The inner head surfaces 40 are positioned facing one another. The teeth 44 allow the tong heads 24 to firmly grip a charcoal briquette 60 or pieces thereof.

The tong head 24 also includes two panels 46 oriented at an angle. The inner head surface 40 defines an angle less than 180 degrees. This design creates a cradling effect to better hold the charcoal briquette 60. In the exemplary embodiment, the tong head 24 is less than three inches long and less than three inches wide. In other words, the tong head 24 is sized to match charcoal briquettes 60, which are usually about two inches wide, two inches long, and one inch thick.

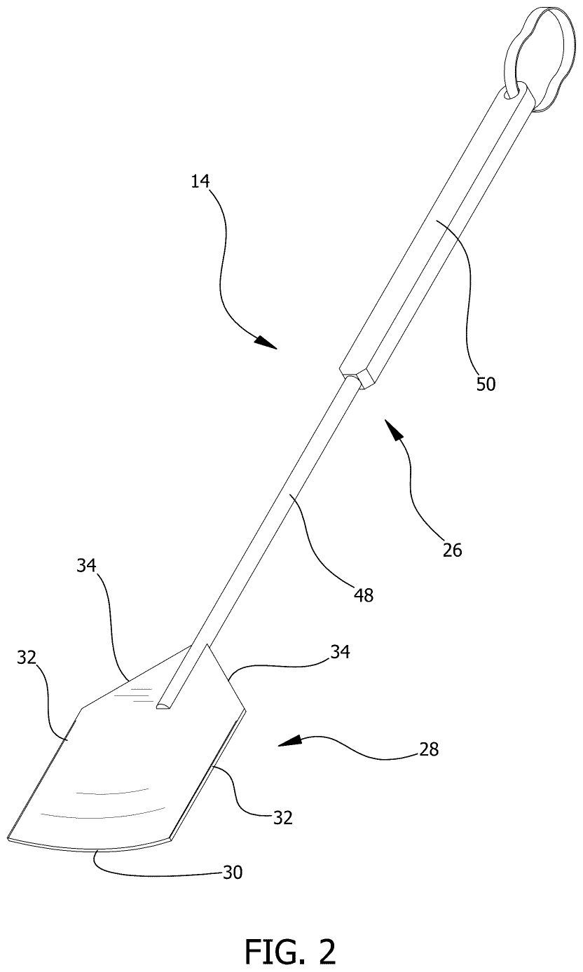

FIGS. 1 and 2 show an exemplary embodiment of the shovel 14. The shovel shaft 26 includes a rod 48 and a handle 50 attached to the rod 48. The rod 48 is integrally formed with the shovel head 28, though in another possible embodiment the shovel head 28 could be coupled to the rod 48, such as by a threaded connection. The shovel head 28 includes a pair of rear edges 34 extending from the side edges 32 to the rod 48. In the exemplary embodiment, each of the rear edges 34 of the shovel head 28 is oriented at an obtuse angle to a respective one of the side edges 32 of the shovel head 28. However, in another possible embodiment, the rear edges 34 could be parallel to the front edge 30. In the exemplary embodiment, the shovel head 28 is slightly convex, though in another possible embodiment the shovel head 28 could be completely flat.

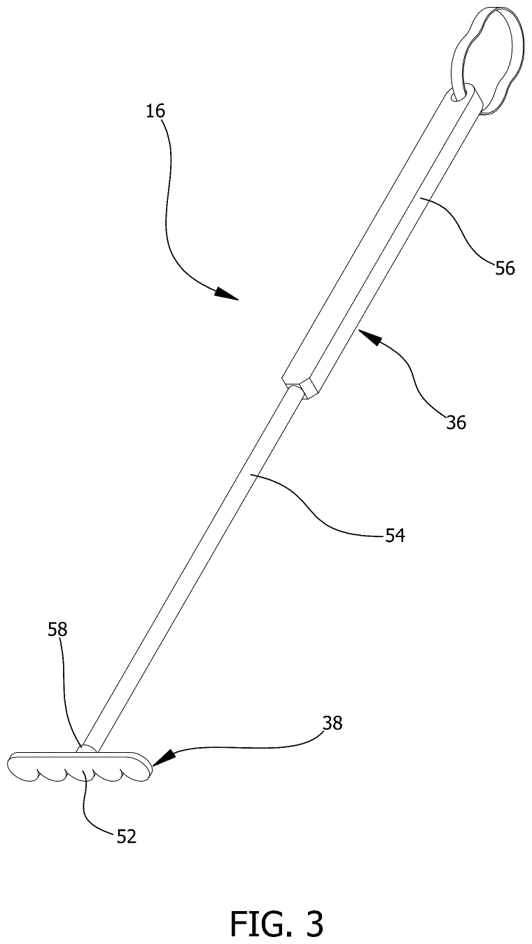

FIGS. 1 and 3 show an exemplary embodiment of the rake 16. The rake head 38 includes a plurality of rake teeth 52 designed to scrape wires of a grate of a grill 62. While the rake 16 is generally used to rake multiple charcoal briquettes 60 to move them from one position to another, the rake 16 can also be used to scrape the wires of a grate of a grill 62 to clean off food and charcoal residue. The rake head 38 is less than six inches wide. The rake shaft 36 includes a bar 54 and a grip 56 attached to the bar 54. The rake head 38 includes a receptacle 58 designed to couple with the bar 54, such as by a threaded connection. In another possible embodiment, the rake head 38 could be integrally formed with the bar 54.

In one possible embodiment, each of the rake 16, the shovel 14, and the tongs 12 are made of metal. In one possible embodiment, the metal has a coating thereon, such as a matte black finish. Hangers can be included on each as well, as are well known with grilling tools.

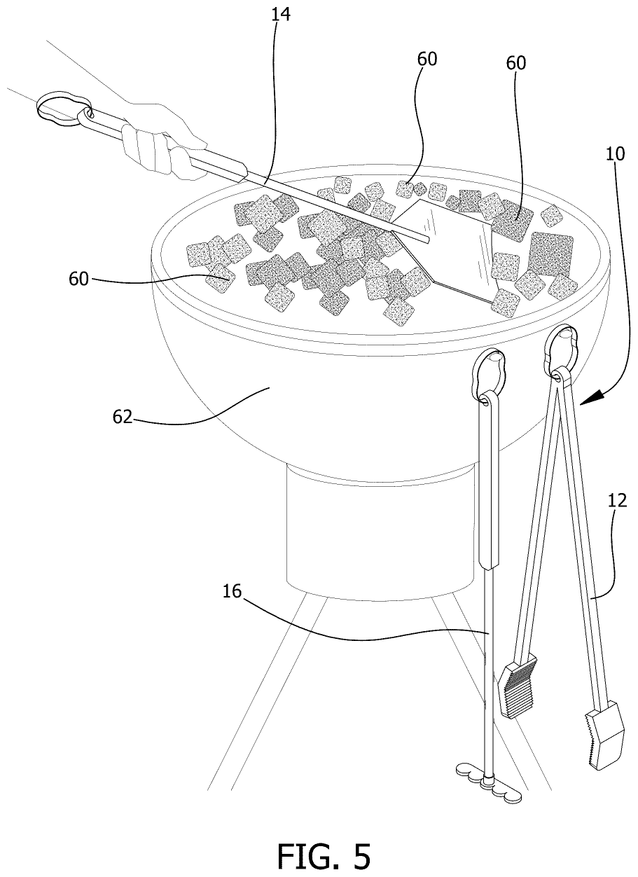

FIG. 5 shows one possible use of the charcoal grilling tool kit 10, in which the shovel 14 is being used to scatter or move around charcoal briquettes 60 on a grill 62. As discussed herein, the tongs 12 could be used to pick up and move individual charcoal briquettes 60. The rake 16 could be used to scrape up one or charcoal briquettes 60 and pieces thereof. Both the rake 16 and the shovel 14 could be used to clean out ash and residues. While the charcoal grilling tool kit 10 is described as being used with hot charcoal briquettes 60, the charcoal grilling tool kit 10 could also be used to manipulate cold charcoal briquettes 60, whether new or used, to avoid the user having to dirty his or her hands.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A charcoal grilling tool kit for handling hot charcoal briquettes comprising:
tongs including a pair of arms, each of said arms including a first arm end and a second arm end, said arms being pivotably connected together at said first arm end of each of said arms, each of said arms including a tong head being positioned at said second arm end;
a shovel including a shovel shaft and a shovel head being attached to said shovel shaft, said shovel head including a front edge and a pair of side edges, said front edge being positioned perpendicular to a longitudinal axis of said shovel shaft, each of said side edges being positioned parallel to the longitudinal axis of said shovel shaft; and
a rake including a rake shaft and a rake head being attached to said rake shaft, said rake head being positioned perpendicular to a longitudinal axis of said rake shaft.

2. The charcoal grilling tool kit of claim 1, wherein:
said tong head has an inner head surface and an outer head surface;
said inner head surface includes a plurality of teeth; and
said inner head surfaces are positioned facing one another.

3. The charcoal grilling tool kit of claim 2, wherein:
said tong head includes two panels oriented at an angle; and
said inner head surface defines an angle less than 180 degrees.

4. The charcoal grilling tool kit of claim 1, wherein said tong head is less than three inches long and less than three inches wide.

5. The charcoal grilling tool kit of claim 1, wherein:
said shovel shaft includes a rod and a handle attached to said rod;
said rod is integrally formed with said shovel head; and
said shovel head includes a pair of rear edges extending from said side edges to said rod.

6. The charcoal grilling tool kit of claim 5, wherein each of said rear edges of said shovel head is oriented at an obtuse angle to a respective one of said side edges of said shovel head.

7. The charcoal grilling tool kit of claim 1, wherein said shovel head is slightly convex.

8. The charcoal grilling tool kit of claim 1, wherein said rake head includes a plurality of rake teeth configured to scrape wires of a grate of a grill.

9. The charcoal grilling tool kit of claim 1, wherein said rake head is less than six inches wide.

10. The charcoal grilling tool kit of claim 1, wherein:
said rake shaft includes a bar and a grip attached to said bar; and
said rake head includes a receptacle configured to couple with said bar.

11. The charcoal grilling tool kit of claim 3, wherein said tong head is less than three inches long and less than three inches wide.

12. The charcoal grilling tool kit of claim 11, wherein:
said shovel shaft includes a rod and a handle attached to said rod;
said rod is integrally formed with said shovel head; and
said shovel head includes a pair of rear edges extending from said side edges to said rod.

13. The charcoal grilling tool kit of claim 12, wherein each of said rear edges of said shovel head is oriented at an obtuse angle to a respective one of said side edges of said shovel head.

14. The charcoal grilling tool kit of claim 13, wherein said shovel head is slightly convex.

15. The charcoal grilling tool kit of claim 14, wherein said rake head includes a plurality of rake teeth configured to scrape wires of a grate of a grill.

16. The charcoal grilling tool kit of claim 15, wherein said rake head is less than six inches wide.

17. The charcoal grilling tool kit of claim 16, wherein:
said rake shaft includes a bar and a grip attached to said bar; and
said rake head includes a receptacle configured to couple with said bar.
